(19) United States
(12) Patent Application Publication
(10) Pub. No.: US 2019/0250907 A1
(43) Pub. Date: Aug. 15, 2019

(54) TECHNIQUES FOR SIMPLIFIED SERVICE MODIFICATION UTILIZING A SPLIT DESIGN-ASSIGN FRAMEWORK

(71) Applicant: Telefonaktiebolaget LM Ericsson (publ), Stockholm (SE)

(72) Inventors: Igor SHEGELMAN, Thornhill (CA); Ihsan SHAH, Piscataway, NJ (US); Andrii VLASOV, Piscataway, NJ (US); Daniel WILSON, Jackson, NJ (US)

(21) Appl. No.: 16/335,230

(22) PCT Filed: Oct. 18, 2016
(86) PCT No.: PCT/IB2016/056238

§ 371 Date: Mar. 20, 2019

Related U.S. Application Data
(60) Provisional application No. 62/401,135, filed on Sep. 28, 2016.

(51) Int. Cl. G06F 8/658; G06F 9/50; H04L 29/08; H04L 12/24

(52) U.S. Cl. CPC G06F 8/658; H04L 41/5041; H04L 67/34; G06F 9/5005

(57) ABSTRACT

Techniques for service modification utilizing a split design-assign framework are described. An existing service design for a service is obtained. The input data structure that would be used to build the desired service design from scratch is obtained or computed. A design “add” function is executed using this new input data structure as if building the desired service design for the first time. A difference is determined between the existing service design and the desired service design, resulting in instructions for objects needed to be created, modified, and/or deleted in the existing service design to achieve the desired service design. These instructions are applied to an inventory system, thereby achieving the desired service design.

### TECHNICAL FIELD

Embodiments relate to the field of computer systems; and more specifically, to techniques for simplified service modification utilizing a split design-assign framework.

### BACKGROUND

Telecommunication service providers offer a variety of services to their customers, such as Digital Subscriber Line (DSL) services, Fiber to the X (or “FTTx”, such as Home (FTTH), Premise (FTTP), Node (FTTN), Cabinet (FTTC), Building (FTTB), etc.), Carrier Ethernet, Layer 3 Virtual Private Network (VPN) (L3VPN) service, Layer 2 VPN (L2VPN) service, Synchronous Optical Network (SONET) service, etc.

To provide these services, telecommunication service providers may utilize service management software reliant upon The Applications Framework (formally, the Telecom Application Map (TAM)), which describes the role and the functionality of various applications that deliver Operations Support System (OSS) and Business Support System (BSS) capabilities, and provides a common language and means of identification for buyers and suppliers across all software application areas.

Upon a customer request (or “order”) for a new service (e.g., an “add” request), the service management software can typically perform a set of straightforward, well-defined operations to configure the underlying architecture (or “cloud architecture”) accordingly, such as by changing port associations, transmission/reception time slots, connection identifiers, modifying system attributes, adding or configuring virtual machines (VMs), etc. Similarly, upon a customer request to end or terminate an existing service (e.g., a “disconnect” request), the service management software can also typically perform a set of straightforward, well-defined operations to configure the underlying architecture accordingly.

However, current service management software implementations struggle when a customer requests a modification to an existing service (e.g., a “change” request). Such difficulties handling change requests may occur due to a variety of reasons.

First, there can be many considerations driving the change. Some aspects are driven by changes to the service specifications (i.e., the customer requirements), while some aspects are driven by provider considerations (e.g., resource utilization or faults) that might appear in the change request as hints about resource utilization (e.g., use a first resource and/or do not use a second resource).

Second, there are often multiple ways to request changes. Often, more than one may be used in a solution depending upon the initiator of the change and the particular use case. Sometimes, a complete new service specification is provided by a customer, which may possibly be accompanied by resource hints or even a total pre-specification of resources to be utilized. Sometimes, however, only incremental changes to the existing service specification and/or hints driving incremental changes to the consumed resources are provided. Further, sometimes complete new service specifications for well-defined sub-sections of the overall specification are provided, while unaltered sub-sections are left out of the change request.

And third, the service management software performing the change must often consider the existing (in-effect) design, and work to minimize differences with the new design by reusing relevant parts of the existing design where possible.

Because of these multiple and complex requirements for making changes, this processing is often built up over time in an ad-hoc fashion. For example, the first iteration of many solutions is often limited to simply enabling add and disconnect processing, with change processing left as a future problem and afterthought. Over time, specific change cases may be developed, which proliferate into a series of special purpose functions (and likely, “spaghetti-code”), each handling some specific kind of change such as swapping an endpoint or changing a particular attribute. While this often appears to be a practical way to build a complex solution, there are several serious problems with this approach.

First, this approach can lead to larger and larger amounts of time required to extend or maintain the system over time, as there is a strong tendency to keep rebuilding aspects of the overall process to apply them in the specific change cases. This redundancy is an inefficient way to build out a solution's total capabilities. Also, this redundancy sets up high ongoing maintenance costs as new functionality is added over time—not only must the “add” function be updated, but each of the special purpose “change” functions must also be separately enhanced.

Second, this approach may not succeed in fully addressing changes, as often it never converges to a solution that can handle any kind of change—either every special case is not built, and/or combinations of changes cannot be handled. Moreover, it may be that the frequency of each special case cannot justify the cost of automation, but the sum of many unaddressed requirements can be a weak system.

Third, eventually the attempt to overcome the second problem can lead to additional complexity and cost. A layer of orchestration may be built to break up complex change requests into a sequence of steps in accordance with the available specialized change functions, but this new layer can itself be complex and will bring both initial and maintenance costs.

Accordingly, the inherent complexity of “change” processing often leads to poor solutions resulting in both high costs and limited functionality. Thus, solutions for service modification are strongly desired that avoid these shortcomings.

### SUMMARY

Systems, methods, apparatuses, computer program products, and machine-readable media are provided for simplified service modifications utilizing a split design-assign framework.

According to some embodiments, a method is performed by a service management module implemented by one or more computing devices. The method includes receiving, at the service management module, a request from a client to modify the existing service. The method also includes obtaining, by a design module of the service management module, a first service design for the existing service. The first service design indicates how the existing service is deployed within a service infrastructure and includes a plurality of object statements corresponding to a plurality of objects of an inventory system that correspond to a plurality of resources of the service infrastructure that are utilized by the existing service. The method also includes obtaining, by the design module, a second service design for a modified version of the existing service. The second service design is not the same as the first service design and indicates how the modified version of the existing service could be deployed within the service infrastructure. The method also includes generating, by the design module, a set of one or more instructions based upon determining a difference between the first service design and the second service design. The method also includes executing, by an assign module of the service management module, each of the set of one or more instructions against the inventory system to cause resources to be released or reserved for the modified version of the existing service.

According to some embodiments, a non-transitory machine readable medium provides instructions which, when executed by a processor of a device, will cause the device to implement a service management module operable to modify an existing service utilizing a split design-assign framework by performing operations. The operations include receiving a request from a client to modify the existing service. The operations also include obtaining, by a design module of the service management module, a first service design for the existing service. The first service design indicates how the existing service is deployed within a service infrastructure and includes a plurality of object statements corresponding to a plurality of objects of an inventory system that correspond to a plurality of resources of the service infrastructure that are utilized by the existing service. The operations also include obtaining, by the design module, a second service design for a modified version of the existing service. The second service design is not the same as the first service design and indicates how the modified version of the existing service could be deployed within the service infrastructure. The operations also include generating, by the design module, a set of one or more instructions based upon determining a difference between the first service design and the second service design. The operations also include executing, by an assign module of the service management module, each of the set of one or more instructions against the inventory system to cause resources to be released or reserved for the modified version of the existing service.

According to some embodiments, a device includes one or more processors and a non-transitory machine-readable storage medium. The non-transitory machine readable medium provides instructions which, when executed by the one or more processors, will cause the device to implement a service management module operable to modify an existing service utilizing a split design-assign framework by performing operations. The operations include receiving a request from a client to modify the existing service. The operations also include obtaining, by a design module of the service management module, a first service design for the existing service. The first service design indicates how the existing service is deployed within a service infrastructure and includes a plurality of object statements corresponding to a plurality of objects of an inventory system that correspond to a plurality of resources of the service infrastructure that are utilized by the existing service. The operations also include obtaining, by the design module, a second service design for a modified version of the existing service. The second service design is not the same as the first service design and indicates how the modified version of the existing service could be deployed within the service infrastructure. The operations also include generating, by the design module, a set of one or more instructions based upon determining a difference between the first service design and the second service design. The operations also include executing, by an assign module of the service management module, each of the set of one or more instructions against the inventory system to cause resources to be released or reserved for the modified version of the existing service.

According to some embodiments, a device is adapted to modify an existing service utilizing a split design-assign framework. The device includes a module to receive a request from a client to modify the existing service. The device also includes a module to obtain a first service design for the existing service. The first service design indicates how the existing service is deployed within a service infrastructure and includes a plurality of object statements corresponding to a plurality of objects of an inventory system that correspond to a plurality of resources of the service infrastructure that are utilized by the existing service. The device also includes a module to obtain a second service design for a modified version of the existing service. The second service design is not the same as the first service design and indicates how the modified version of the existing service could be deployed within the service infrastructure. The device also includes a module to generate a set of one or more instructions based upon determining a difference between the first service design and the second service design. The device also includes a module to execute each of the set of one or more instructions against the inventory system to cause resources to be released or reserved for the modified version of the existing service.

Accordingly, embodiments provide a well-defined approach to building design/assign functionality that supports change processing.

Embodiments can directly reuse design/assign “add” functionality that may already be utilized for implementing new services, thus eliminating any need to create duplicate logic to support special change cases. This can reduce not only the initial cost of developing design/assign functionality, but also reduce future maintenance costs.

In some embodiments, once the design/assign “add” functionality is implemented, basic change functionality driven by a complete new service specification is essentially free. This basic change functionality is complete in that it can accommodate any kind of change and any combination of changes.

Moreover, some embodiments utilize a process to reconstruct an input message corresponding to the existing design that can accommodate combinations of incremental changes. This capability to reconstruct input from an existing design can also facilitate a reconciliation of inventory (existing design) with an external source of service specifications.

Some embodiments can accommodate well-defined change-specific logic for reusing specific resources from the existing design, which can interwork with the design/assign “add” functionality.

### BRIEF DESCRIPTION OF THE DRAWINGS

The invention may best be understood by referring to the following description and accompanying drawings that are used to illustrate embodiments. In the drawings:

FIG. 1 is a block diagram illustrating a service management module including a design module and assign module that enables simplified service modification utilizing a split design-assign framework according to some embodiments.

FIG. 2 is a flow-type diagram illustrating operations for utilizing an input data structure including service deltas for updating a deployed service in a service infrastructure according to some embodiments.

FIG. 3 is a flow-type diagram illustrating operations for utilizing an input including a full service specification for updating a deployed service in a service infrastructure according to some embodiments.

FIG. 4 is a flow-type diagram illustrating operations for applying a change input data structure to a reconstructed input data structure according to some embodiments.

FIG. 5 is a flow-type diagram illustrating operations for determining a difference between an existing service design and a new service design according to some embodiments.

FIG. 6 is a diagram illustrating an exemplary service design according to some embodiments.

FIG. 7 is a diagram illustrating an input data structure, a change input data structure, and a new input data structure according to some embodiments.

FIG. 8 is a block diagram illustrating an existing service and an updated service according to some embodiments.

FIG. 9 is a flow-type diagram illustrating operations for updating a service by reconciling a stored input data structure with a reconstructed input data structure according to some embodiments.

FIG. 10 is a flow diagram illustrating updating a service instance in a service infrastructure utilizing a split design-assign framework according to some embodiments.

FIG. 11A illustrates connectivity between network devices (NDs) within an exemplary network, as well as three exemplary implementations of the NDs, according to some embodiments.

FIG. 11B illustrates an exemplary way to implement a special-purpose network device according to some embodiments.

### DETAILED DESCRIPTION

The following description describes techniques for simplified service modification utilizing a split design-assign framework which can efficiently and safely perform service updates. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments. However, such notation should not be taken to mean that these are the only options or optional operations, and/or that blocks with solid borders are not optional in certain embodiments.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

Embodiments disclosed herein utilize a split design/assign framework that can obtain an existing service design for a service; compute or obtain the input data structure that would be used to build the new/desired service design from scratch; execute a design “add” function using this new data structure as if building the service for the first time; determine a difference between the existing service design and the new/desired service design, resulting in instructions for objects needed to be created, modified, and/or deleted in the existing service design to achieve the new service design; and apply these instructions to an inventory system, thus achieving the new/desired service design.

Accordingly, embodiments provide a well-defined approach to building design/assign functionality that supports change processing.

Embodiments can thus directly reuse design/assign “add” functionality that may already be utilized for implementing new services, thus eliminating any need to create duplicate logic to support special change cases. This can reduce not only the initial cost of developing design/assign functionality, but also reduce future maintenance costs.

In some embodiments, once the design/assign “add” functionality is implemented, basic change functionality driven by a complete new service specification is essentially free. This basic change functionality is complete in that it can accommodate any kind of change and any combination of changes.

Moreover, in some embodiments a process to reconstruct an input message corresponding to the existing design is provided that can thus accommodate combinations of incremental changes. Additionally, this capability to reconstruct input from an existing design can also facilitate a reconciliation of inventory (existing design) with an external source of service specifications.

Some embodiments can, if needed, accommodate well-defined change-specific logic for reusing specific resources from the existing design, which can interwork with the design/assign “add” functionality.

Accordingly, embodiments provide a time/cost effective and comprehensive approach to implementing design/assign change functionality.

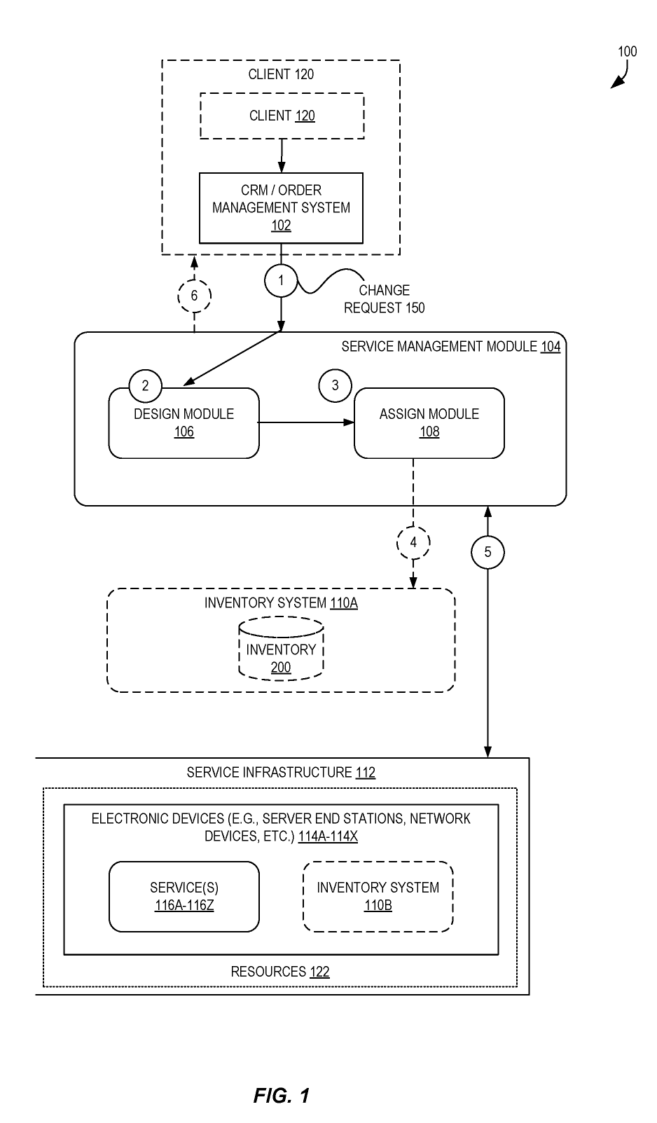

FIG. 1 is a block diagram illustrating a system 100 with a service management module 104 including a design module 106 and assign module 108 that enables service modification utilizing a split design-assign framework according to some embodiments. The system 100 includes a client 120, a Customer Relationship Management (CRM)/Order Management System 102 (or “CRM/OMS”), a service management module 104, an inventory system 110A/110B, and a service infrastructure 112 (e.g., a cloud infrastructure) with one or more electronic devices 114A-114X implementing one or more services 116A-116Z.

As illustrated, a client 120 (which may be distinct from or include the CRM/OMS 102) initiates a request to change one or more aspects of a service (e.g., service 116A). For example, a client 120 may interact with the CRM/OMS via a web application that serves as an interface for the client 120 to interact with the service management module 104.

Thus, at circle ‘1’, the CRM/OMS 102 sends a change request 150 to the service management module 104 (e.g., based upon the client-initiated request, or serving as the client-initiated request). The change request 150 may include a variety of types of information, but often identifies the particular deployed service (e.g., using a service identifier) and includes data identifying one or more changes to the deployed service. For example, the change request 150 can include an input data structure with a set of changes, a full modified service design specification, etc., as described later herein.

At circle ‘2’, the design module 106 obtains the change request 150 (or is otherwise notified of the existence of the change request 150), and may determine whether the change request is feasible and/or how to provision resources to affect the desired change (e.g., reserve ports, designate a link to be added, etc.). Circle ‘2’ can thus include generating a set of instructions indicating what actions are to be taken to implement the desired change.

Thereafter, the design module 106 causes the assign module 108 to (at circle ‘3’) interact with an inventory system 110A/110B to prepare the service infrastructure 112 to be updated for the change. For example, the assign module 108 may be notified of the set of instructions (e.g., generated by the design module 106) and can “execute” these instructions via a set of one or more commands (at circle ‘4’) to an inventory system 110A/110B, to thus update an inventory 200 (e.g., a database maintaining records of what resources 122 of the service infrastructure 112 are being utilized (and will be utilized) by particular services 116A-116Z). These commands may cause the inventory system 110A/110B to reserve resources 122 for the to-be-changed service 116A, release resources 122 for the to-be-changed service 116A, remove amounts of available capacity/resources 122, etc. Resources 122 may include, for example, ports, time slots, connection identifiers, etc.

At some point, the “changes” needed to implement the change request 150 will be “activated” (e.g., at circle ‘5’) to thus cause the service to be changed.

For example, in some embodiments, the CRM/OMS 102 may invoke the service management module 104 in advance of when a change is expected to be needed, which could be hours, days, weeks, or even months in advance. This invocation, and subsequent use of the design module 106 and assign module 108 (for the design/assign operations) can be performed to guarantee that the required resources have been reserved within the inventory 200. Then, upon the actual need to implement the change, the CRM/OMS 102 could send an instruction to an activation module (non-illustrated, but part of the service management module 104) to “active” the changes, which can send commands to the service infrastructure 112 (at circle ‘5’) to make the changes. Upon this activation being completed, the service management module 104 can, for example, communicate with the inventory system 110A/110B to release any resources that are no longer used/needed, change the status of the associated resource reservation (e.g., from “planned” or pending to instead be “active”), etc.

Optionally, at circle ‘6’ the service management module 104 can then provide a notification to the CRM/OMS 102 and/or client 120 of the successful activation/deployment of the updated service.

However, in some embodiments an inventory system 110A/110B need not be utilized to track how the service infrastructure 112 is to be updated for the change. Instead, the service management module 104 can also be configured to communicate “directly” with the service infrastructure 112 to cause the inventory system 110A/110B to reserve resources 122 for the to-be-changed service 116A, remove amounts of available capacity/resources 122, etc.

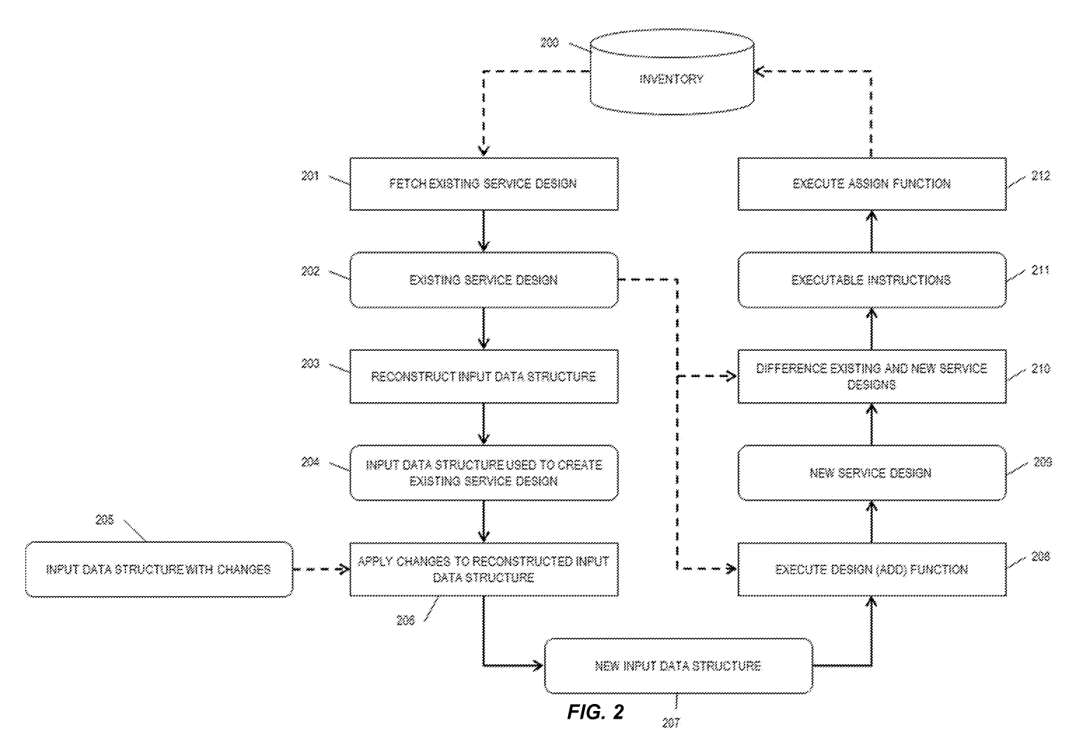

For further detail, we turn to FIG. 2, which is a flow-type diagram illustrating operations for utilizing an input data structure including service deltas for updating a deployed service in a service infrastructure according to some embodiments. In some embodiments, some or all of the operations of FIG. 2 may be performed by the service management module 104. Thus, the operations in this flow diagram and others may be described with reference to the exemplary embodiments of the other figures. However, it should be understood that the operations of the flow diagrams can be performed by embodiments other than those discussed with reference to the other figures, and the embodiments discussed with reference to these other figures can perform operations different than those discussed with reference to the flow diagrams.

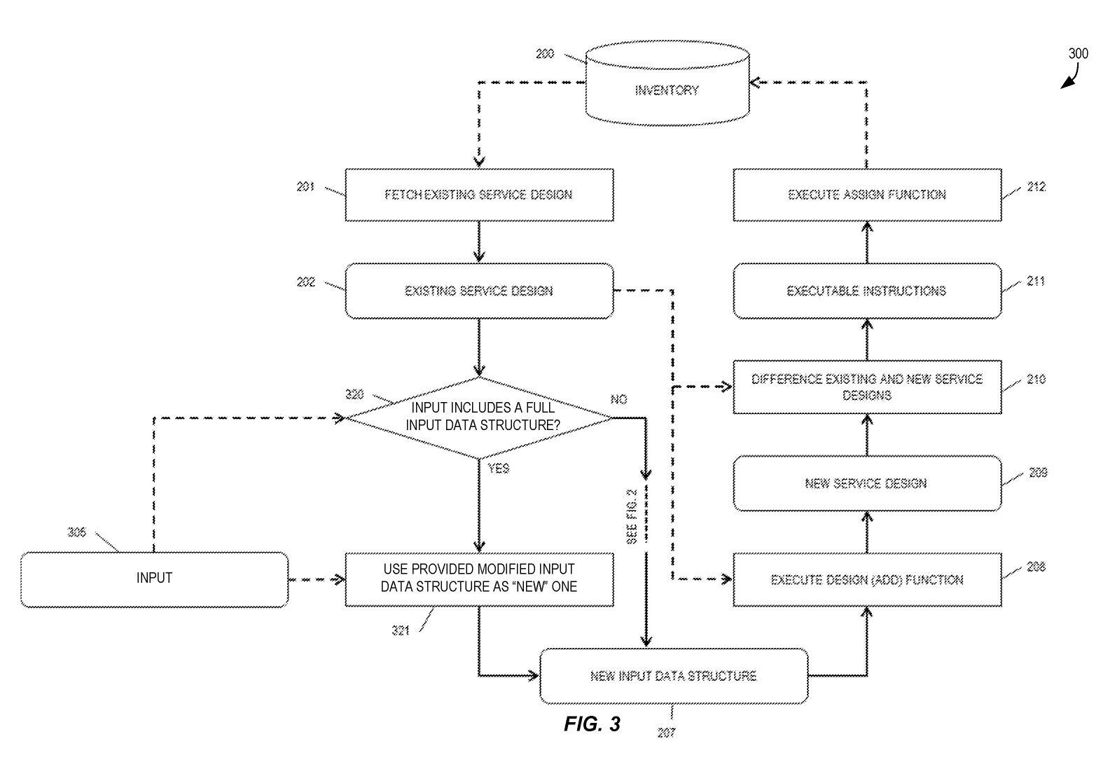

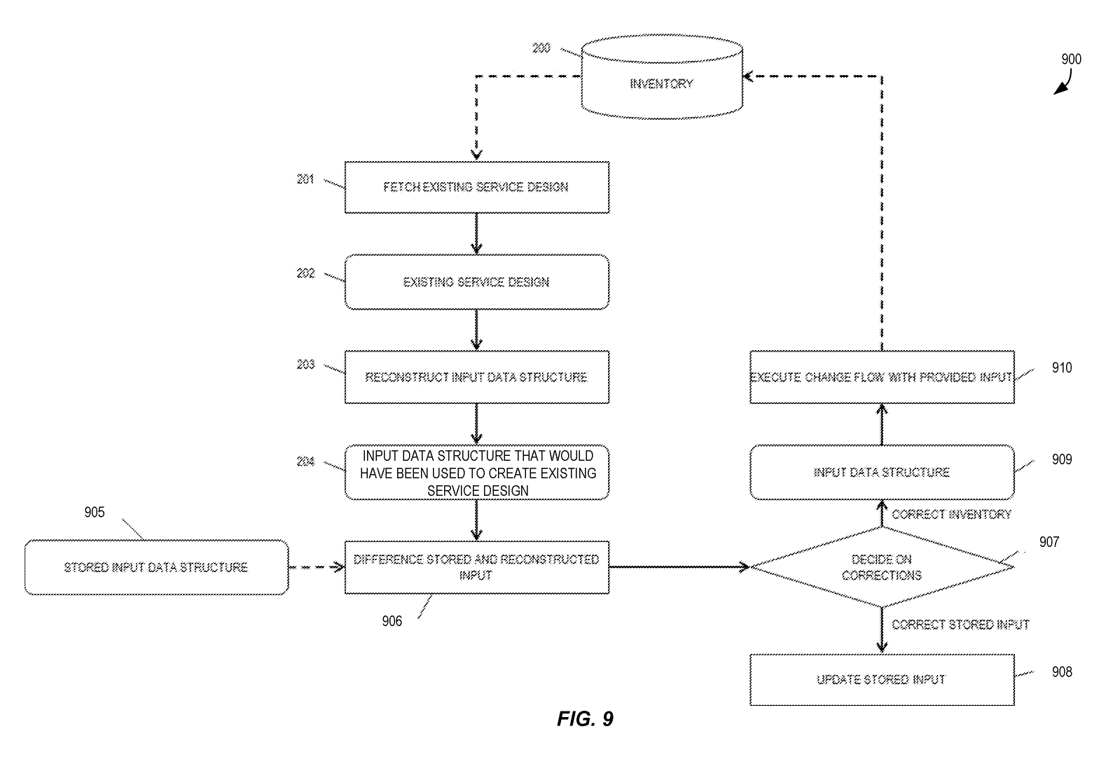

Additionally, in contrast to the typical use of dashes as representing optional elements/features, in FIG. 2 and others (e.g., FIG. 3, FIG. 9), dashed arrows may be used to refer to data flows, while solid arrows may be used to refer to logical flows. However, it is to be understood that some of these elements/operations/features—despite being or not being dashed—may be optional (or not utilized) in some embodiments.

Thus, one algorithm for service modification is described graphically in FIG. 2. The operations may be implemented as plugins, each with well-defined inputs and outputs. Most plugins can be provided by the framework (e.g., of the service management module 104), which is technology agnostic and provides “boilerplate” type logic common to implement many technologies. In some embodiments, a plugin (performing block 203) can be provided by an automation (or “value pack”, which provides technology-specific logic for a particular type of service, such as L3VPN, L2VPN, etc., in the telecom environment). Accordingly, in some embodiments the framework provides a significant amount of logic, allowing automations to focus upon the specifics of the technology/services that they support.

In some embodiments, performing change processing may include utilizing two inputs: (1) an existing service design (e.g., as stored in the inventory 200) specified by a service name/identifier; and (2) a change request input data structure (e.g., eXtensible Markup Language (XML)) that specifies what should be changed. This change request input data structure may include “deltas” (or differences) between the modified and existing service, a complete new service specification of the desired service, or a combination of both. The change request input data structure may be provided to the service management module 104 as part of change request 150.

FIG. 2 illustrates operations where the input data structure includes deltas. Block 201 may be performed by the design module 106, where an existing service design is fetched (e.g., from inventory 200), which can occur based on a provided service identifier/name (e.g., from change request 150), thus resulting in an existing service design 202. This existing service design 202 may be kept, by the design module 106, using an in-memory representation.

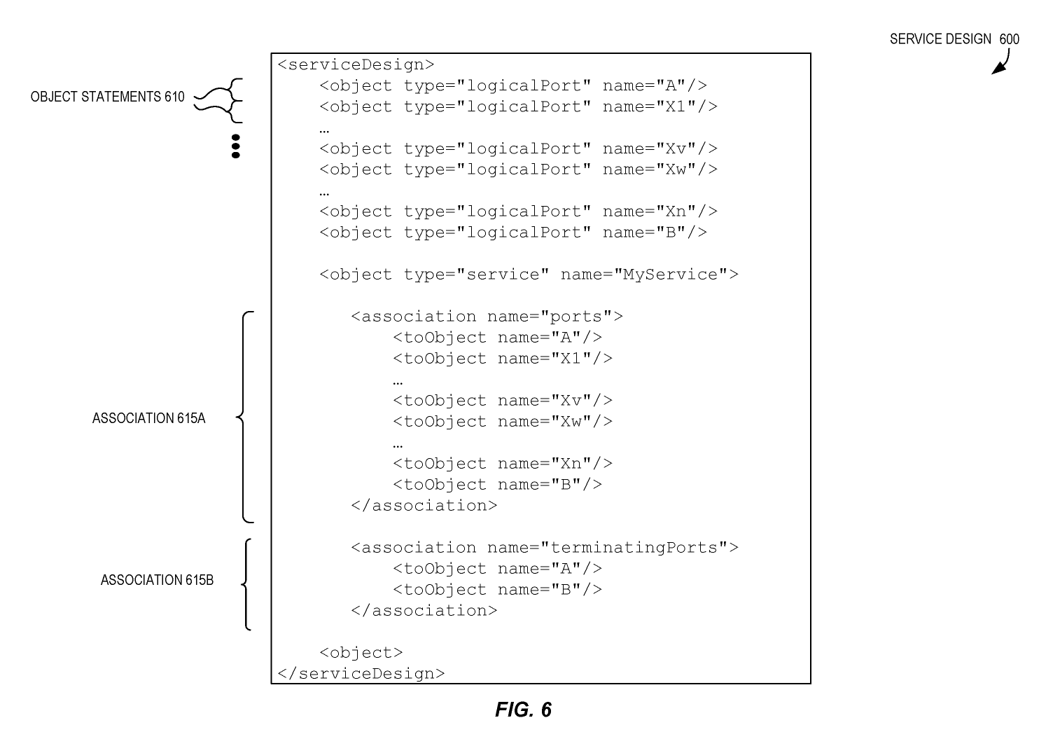

An example of a service design is provided in FIG. 6, which is a diagram illustrating an exemplary service design 600 according to some embodiments. This service design format includes a list of “objects.” An object listed in the service design represents an object (also known as an entity) in an inventory system 110A/110B.

Each object can have a type attribute value indicating the type of an object. For example, some types used in a telecommunications service system could include one or more of a “logicalPort” (where logicalPorts are only created when a physical port is being used by a service), “service”, “crossConnect”, “link”, etc. As illustrated, a number of object statements 610 are shown having type “logicalPort”, and an object of type “service” is also illustrated.

Each object can also have a name attribute value which, for simplicity, may be unique across all objects of the same type (or, among all objects). In this figure, some of the names include “A”, “X1”, “Xv”, etc.

Some objects can also have an optional “action” attribute value to be described later herein, and/or other attributes (not illustrated for the sake of simplicity).

An object may also include a list of associations (e.g., associations 615A-615B) to other objects. In this example, the service object named “MyService” includes two associations: a first association 615A named “ports” for all ports involved in the service, and a second association 615B named “terminatingPorts” including a subset of those ports that act as the endpoints of the “MyService” service.

In some embodiments, an association may have a list of “toObject” element statements, each indicating the target of the association. As shown, the “terminatingPorts” association 615B under the service “MyService” includes “toObject” elements referencing ports “A” and “B.” Thus, there will be metadata in the system that defines that terminatingPorts association from “service” object must reference objects of type logicalPort. This particular association, therefore, specifies that MyService has terminating ports A and B.

Turning back to FIG. 2, block 203 may be performed by the design module 106, and can include reconstructing an input data structure. This reconstruction may occur based upon the fetched existing service design 202, and the resulting input data structure 204 can be a data structure that mimics (or duplicates) one that was earlier used to create the service design in the first place. For example, if the service design contains customer-facing ports A and B (as well as intermediate ports X₁ . . . Xₙ connecting the customer-facing ports in the network), the input data structure would specify that the service needs to have endpoints A and B. Note that the intermediate ports (computed by the design function when the service was originally created) are irrelevant to the input data structure. In some embodiments there is 1-to-1 mapping between the input data structure and the relevant portion of the service design. In some embodiments, the resulting input data structure can be an XML-based data structure, and in some embodiments this step is service-specific and can be performed by an automation plugin.

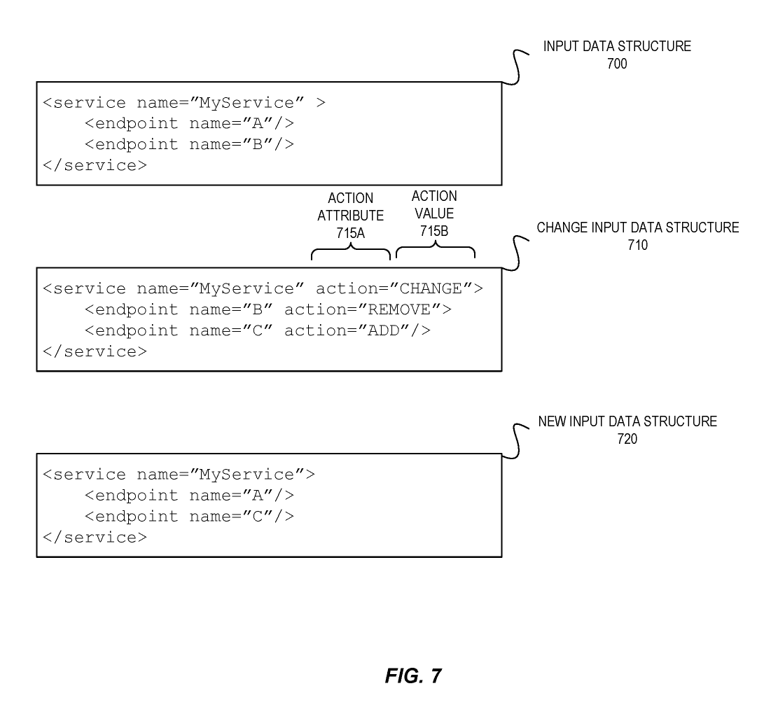

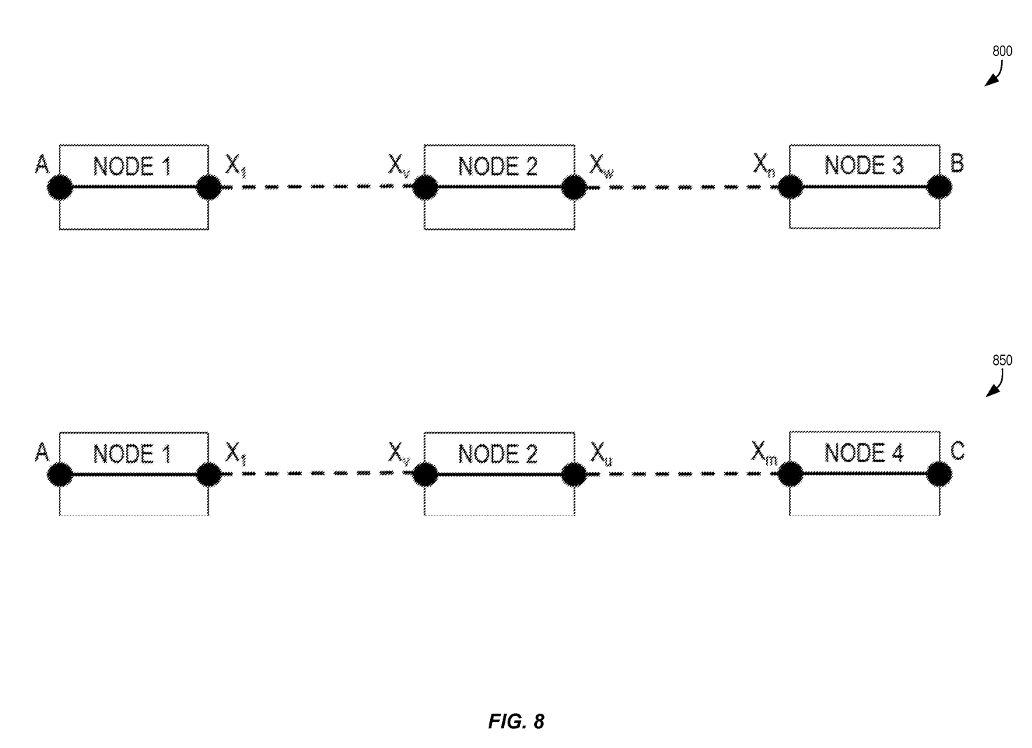

For the sake of understanding, the exemplary service design 600 of FIG. 6 may correspond to the service 800 illustrated in FIG. 8, which is a block diagram illustrating an existing service 800 and an updated service 850 according to some embodiments. As shown in FIG. 8, the service 800 includes at least three nodes (here represented as “NODE 1”, “NODE 2”, and “NODE 3”) with two customer-facing ports (or endpoints) A and B (which may be specified by the client/customer) together with four intermediate ports (X₁ . . . Xₙ). As described above, the intermediate ports may be unknown to the client/customer (as they relate to the “internal” configuration of the service infrastructure 112), and thus, the input data structure in some embodiments will not have data corresponding to this information (i.e., in some embodiments the input data structure does not have infrastructure-internal data, while the service design does). That is, in some embodiments, the input data structure comprises less data than the service design. For example, an exemplary input data structure 700 corresponding to the service 800 is illustrated in FIG. 7, which is a diagram illustrating an input data structure 700 (and a change input data structure 710, which corresponds to the input data structure with changes 205 of FIG. 2, and new input data structure 720, to be described later herein) according to some embodiments. This input data structure, which can be organized in a similar XML-type manner (e.g., a text-based, hierarchical structure) and describes a service (with a name of “MyService”) having two entries corresponding to the two customer-facing endpoints A and B.

As another example, an input data structure can describe from the customer perspective the service that is requested, e.g., a customer may have two physical addresses used by two offices and would like the Local Area Networks (LANs) at each office to be connected to the LAN at the other office. However, the customer does not have any visibility into what the service provider needs to do to connect these two offices, which will thus not be part of the input data structure but will be reflected in the service design, which describes the resources in the service provider's system that are configured to connect these two customer locations to each other. For example, the service design in this example can include configuration data about a router (or “node”) at each customer location, as well as configurations of various intermediate routers in the service provider's network.

Turning back to FIG. 2, the next operations are at block 206, where changes specified in the input data structure 205 are applied to the reconstructed input data structure 204. As indicated above, in some scenarios a client 120 may provide a set of changes (e.g., as part of change request 150), whereas in other scenarios other data may be provided.

For example, in some embodiments the client 120 may provide the change input data structure 710 of FIG. 7, which is similar to the input data structure 700 but includes, for the service, an action attribute 715A having an action value 715B of “change”, indicating that the service is to be changed according to the following data: here, the statement for the first endpoint named “B” also has an action attribute 715A having the action value 715B of “REMOVE” (indicating that endpoint “B” is to be removed from the deployed service) and the second statement for the second endpoint named “C” also has an action attribute 715A having the action value 715B of “add” (indicating that endpoint “C” is to be added to the deployed service).

For example, block 206 can include making changes in the reconstructed input data structure 204 based upon the changes (e.g., the action values), which in this example can include removing the second endpoint statement for endpoint “B” (in input data structure 700) and adding a new endpoint statement for endpoint “C”), to result in the “new” input data structure 720 (which corresponds to the new input data structure 207 of FIG. 2). It is to be understood, however, that this simple example is merely for the sake of explanation and ease of understanding, and that the data structures (e.g., service designs, input data structures) used in many real-world scenarios can be far larger and more complex.

Accordingly, the result is a new input data structure 207 that can be used (e.g., by design module 106) to “build” the new service from scratch reflecting the changes. Thus, given the new input data structure 207, block 208 includes executing a “design” function, which can be the same logic that is used to design any new service from inputs using inventory data. In our example, this function determines how to connect ports A and C in the network via intermediate ports—e.g., X₁ to Xₘ (see service 850 of FIG. 8). In some embodiments, the design function for adding a new service is service-specific, and it can be provided by an automation as part of the “add” processing implementation. The result of block 208 is a new service design 209, which in our example represents the topology of the updated service 850 in FIG. 8.

In some embodiments, this “design add” processing can be configured to be aware that it is being executed in the “change” context, and perhaps may utilize the existing service design (202, as indicated by the dashed data flow arrow between 202 and 208). This can allow for the re-use of resources—e.g., while port X₁ could be marked in inventory 200 as being used (or “not available”), the design add function (block 208) could still select it based upon detecting, within the existing service design 202, that X₁ already belongs to this service (i.e., is utilized by this service).

In some embodiments, to allow for such resource re-use, a set of existing “preferred” resources is made available to the design add function 208 and can be passed to functions that select resources for a service. Such functions can consider a resource to be “available” to be utilized (in the new service design 209) when it is either marked as unused (in the inventory 200), or exists within the set of preferred resources that is provided (e.g., as part of existing service design 202). In some embodiments, when there are multiple resource options with equal costs that are available and that include a resource in the preferred set, these functions can be configured to select the resource in the preferred set.

Continuing the change example where port B is replaced with port C, the routing function (of or called by the design function 208) would be asked to find connectivity between ports A and C with preferred ports X₁ . . . Xₙ. When searching for possible outgoing ports from Node 1, the routing function would pick X₁, as it is preferred. When searching for possible outgoing ports from Node 2, the routing function may consider both X_{w} (as it is preferred) and Xᵤ (as it is available). In the end, the routing function may be configured to pick Xᵤ (despite it not being preferred) as the path through Xᵤ to C may be cheaper (i.e., of less “cost”) than the path from X_{w} to C or perhaps because there is no connectivity from X_{w} to C.

When executing design add 208 in the context of add processing (as opposed to the change processing focused upon herein), the set of preferred resources may be empty. However, in some cases, the input data structure itself can specify certain preferred resources.

At block 210, which also may be performed by the design module 106, a difference between the existing service design 202 and the new service design 209 is determined. This can be performed generically, as described below. The result is a list of executable instructions 211 that need to be performed against the existing service to achieve the new service.

Thus, given the existing service design 800 and the new service design 850 represented in FIG. 8, the resulting executable instructions 211 would include instructions to (1) disassociate ports X_{w} . . . Xₙ, and B from the service design; and (2) associate ports Xᵤ . . . Xₘ, and C to the service design.

At block 212 the assign function can be executed, which may be performed by the assign module 108. As described above, the separation of the design and the assign processing allows this algorithm to perform as described herein. In some embodiments, the assign function takes a list of executable instructions 211 (e.g., in a canonical format) and performs them in (or against) an inventory system 110A (having inventory 200).

In some embodiments, the assign function is implemented generically—to determine the order of instructions and then execute the instructions one by one against the inventory system 110A. Then, the assign function becomes service and action agnostic. This can further simplify the amount of logic required for change processing, as the same generic assign function can be used to support add processing, change processing, as well as disconnect processing.

As indicated above, embodiments utilizing these operations can be tremendously extensible. For example, to add a new feature—such as supporting firewalls—the implementer would merely be tasked with updating the “add” function (of block 208) and changing the reconstruct logic (from block 203), instead of having to perform large, complex re-writes of code and/or implementing duplicate logic in additional, new special-purpose code sections.

Instead of receiving an input data structure indicating the changes (e.g., block 205), in some scenarios a full “updated” service specification might be provided from the client 120 as the input 305. To accommodate this functionality, we turn to FIG. 3, which is a flow-type diagram illustrating operations 300 for utilizing an input 305 including a full service specification for updating a deployed service in a service infrastructure according to some embodiments.

FIG. 3 includes several of the same operations as illustrated in FIG. 2; namely, at block 201 an existing service design 202 for the service is fetched from inventory 200. However, at block 320, a determination is made (e.g., by the design module 106) as to whether the provided input 305 includes a full specification of the desired modified service (e.g., whether it includes a full modified input data structure, as opposed to just including/indicating changes to be made). This can occur for a variety of reasons in certain embodiments, such as when an existing input data structure is provided (or otherwise made accessible) to the client 120, who might wish to directly edit the existing input data structure to create a modified input data structure.

For example, it may be the case that some clients of the service management module 104 may maintain and modify the input data structure sent to the service management module 104 (e.g., as part of change request 150). Additionally, such clients may not even be able to compute an input data structure with changes 205. To support such clients, in some embodiments the input 305 may indicate whether it contains either (1) the delta changes since the last request to design and assign this service (i.e., an input data structure with changes 205) or (2) a full service specification of the input including new data, data that is not changing, and omitting data that is being removed (i.e., includes a “full” input data structure).

Thus, when it is determined at block 320 that the input is (or includes) a “full” specification (e.g., including a full input data structure), that provided input data structure can be utilized (at block 321) as the “new” input data structure (at block 207). However, if it is determined at block 320 that the input does not include a full data structure, the operations may continue with operations from FIG. 2, such as blocks 203, 204, and 206, to acquire the new input data structure at block 207. At this point, the operations can mirror those illustrated in FIG. 2, with executing the design “add” function at block 208 to yield a new service design 209, perform a difference between the existing and new service designs at block 210 to yield executable instructions 211, and execute the assign function at block 212 (e.g., by the assign module 108 by executing the executable instructions 211) against the inventory 200.

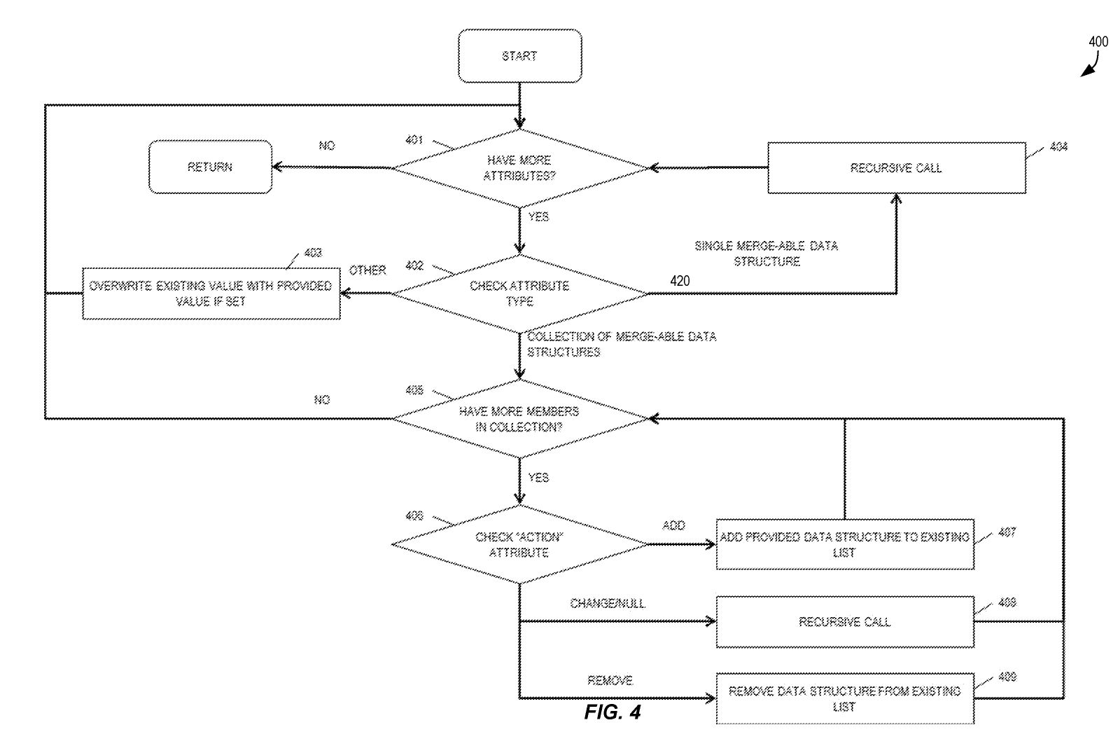

To further explore the operations of FIGS. 2-3, we turn to FIG. 4, which is a flow-type diagram illustrating operations 400 for applying a change input data structure to a reconstructed input data structure according to some embodiments. For example, these operations could be performed as part of block 206 of FIG. 2.

The illustrated algorithm recognizes two types of data structures—those that can be merged (called “merge-able” data structures herein) and all other types of data structures. In some embodiments, a merge-able data structure is one having an attribute “name” populated, which uniquely identifies such data structures, and/or has an “action” attribute populated, which identified what action needs to be performed for the merge-able data structure. For example, each <endpoint> element (of the change input data structure 710) of FIG. 7 has the “name” attribute provided—one with a name of “B” and another with a name of “C”, and the “B” element has a “remove” action while the “C” element has an “add” action.

Although various embodiments can utilize different terminology and possibly other actions, some embodiments use three actions for a Merge-able data structure: “add” (or “ADD”), “change” (or “CHANGE”), and “remove” (or “REMOVE”). As shown in FIG. 7, the change input data structure 710 has a first <endpoint> with an action of “remove” (indicating that the endpoint is to be removed) and a second <endpoint> with an action of “add” (indicating that the endpoint is to be added). The use of such “action” attributes can be a convenient way to allow for the specification of incremental changes in the input (service specification) data structure.

In some embodiments, a merge-able data structure can include one or more collections of merge-able data structures. For example, in the change input data structure 710 of FIG. 7, the <service> data structure has a collection of two <endpoint> data structures. Additionally or alternatively, in some embodiments, a merge-able data structure can have “standalone” merge-able data structures.

Returning to FIG. 4, the operations are performed using the client-provided input data structure and the existing (e.g., reconstructed) input data structure, where each is a merge-able data structure. Of course, the existing data structure represents the “current state” of the service design and the provided data structure represents the changes to be made to change the design to the desired state. In some embodiments, if the provided data structure contains a partial recap of existing input, the algorithm may be configured to only consider for processing the data structures/sub-data structures that have the “action” attribute populated in the provided data structure.

At block 401, given the provided and existing versions of a merge-able data structure, their attributes are iterated over to determine whether there are more attributes remaining. If not, the algorithm may return (e.g., at the end of a function/process call). When an element with an attribute is found, at block 402 a check is made to determine whether the attribute type represents a merge-able data structure or a collection of merge-able data structures. For example, as illustrated in FIG. 7, the “service” element represents a collection of merge-able data structures, whereas each of the “endpoint” elements represent a single merge-able data structure. Although not illustrated, it may also be the case that another type of data structure is present that is not a single merge-able data structure or a collection of merge-able data structures.

At block 403, when the attribute type is neither a merge-able data structure nor a collection of merge-able data structures, then, if the provided attribute value is set, the respective attribute value held by the existing data structure is overwritten with the value held by the client-provided data structure.

However, at block 402 if the attribute type is a single merge-able data structure, then the algorithm can recursively call itself (via path 420) to merge the values of the attributes held by the provided and the existing data structures.

However, at block 402 when the attribute type is a collection of merge-able data structures, then the members of the collection are iterated over (via block 405) within the provided input data structure. After all members are iterated over, the algorithm returns to block 401 to determine whether there are any other attributes to process. However, for each member, at block 406, the value of the “action” attribute of each member is examined.

When the action attribute value is “add,” at block 407 the current member of the provided input data structure collection is added to the corresponding existing input data structure collection.

When the action attribute value is “change” (or, in some embodiments, when it is not specified, i.e., is null), the algorithm can be recursively called at block 408 to merge the current member of the provided collection with a member of the existing collection that has the same name, for example, by replacing/overwriting the previous member with the current member.

When the action attribute value is “REMOVE,” at block 409 the existing collection member with the same name as the current member of the provided collection is removed.

Upon completion of any of blocks 407, 408, and 409, the algorithm returns to block 405, where it is determined whether there are any other members in the collection of merge-able data structures that remain to be processed in an iteration. When all members in the collection have been processed in an iteration, the algorithm returns to block 401 to determine whether there are any other attributes to process. Accordingly, at the end of the processing of the algorithm, the existing input data structure has been updated according to the change input data structure. The updated existing (e.g., reconstructed) input data structure is illustrated as the new input data structure 207 of FIG. 2.

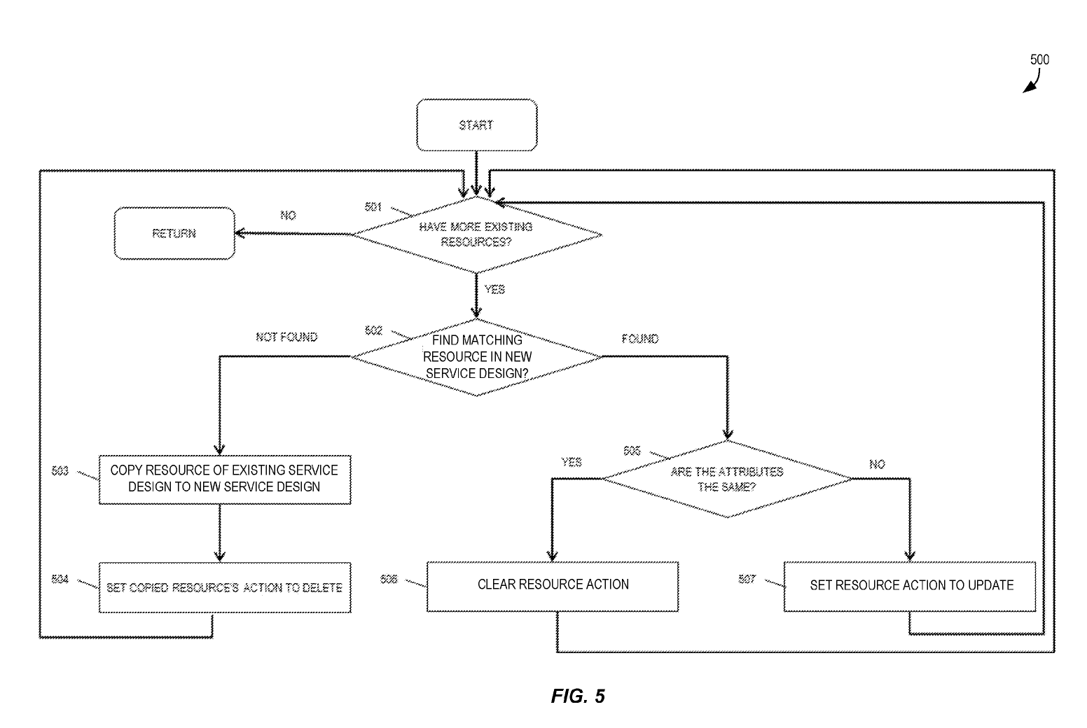

Another set of exemplary operations related to block 210 of FIGS. 2 and 3—will now be introduced with regard to FIG. 5, which is a flow-type diagram illustrating operations 500 for determining a difference between an existing service design and a new service design according to some embodiments. Some or all of these operations may be performed as part of block 210 of FIG. 2 and/or FIG. 3.

The algorithm can be performed utilizing the existing service and the new service design. A service design may be thought of as a graph of vertices connected to other vertices in the graph, where a vertex contains (1) a resource, which could be a resource that needs to be built for the service (e.g., a logical port) or an infrastructure resource being used by the service (e.g., a physical port); (2) an action (e.g., create, update, delete) to be performed on the resource (though in some embodiments, only service-specific resources will have the action attribute set); and/or (3) an “alternativeld” attribute as described below.

As the new service design, in some embodiments, has been created by the design add function that assumed there are no service-specific resources in inventory, all vertices of service-specific resources may have an action of “create.” All vertices that have an action represent executable instructions that will be passed to the assign function.

The algorithm can operate to determine the vertices that should have actions of create, update, or delete for the resources that need to be created, updated or deleted in inventory in order to transition the existing service design to the new service design.

Exemplary operations for the algorithm are depicted in FIG. 5, and include, at block 501 iterating over all the vertices in the existing service design representing service-specific resources. At block 502, a vertex/resource is searched for in the new service design matching the current resource in the existing service design. Exemplary techniques used to find a match are described below.

In some embodiments, the inventory system provides metadata indicating a set of attributes and associations that would make a resource unique. When present, such metadata would be sufficient to match two resources in the existing and new service designs.

In some cases, an attribute used to make a resource unique is generated or selected at the time the service is designed. For example, there might be a resource naming convention that includes current timestamp. In another example, a connection identifier (e.g., an attribute that is also used to uniquely identify a resource) is selected from a pool of available identifiers. In such cases, running the design “add” function on the same input multiple times could result in different resource attribute values. Therefore, such a resource in the existing design may not match an equivalent resource in the new service design, which was built at a different time.

To solve this issue, a vertex representing a resource may have an “alternativeld” attribute. In some embodiments, a service-specific automation provides a value for each such resource in the existing and new service design that would be guaranteed to be the same. For example, if a single service-specific logical port resource is created for each physical port resource, it would be sufficient for the service-specific automation to set the “alternativeld” in the vertex of a logical port to the name of the physical port. Thus, even if logical port unique attributes include some generated connection identifiers or timestamps, equivalent logical ports in the existing and new service designs would always match.

It is to be understood that the “alternativeld” technique also can help with the preservation of the existing service design by avoiding the generation of any new values where the existing ones could be re-used. Thus, the “alternativeld” technique can also be used if the inventory system does not provide metadata describing a resource's unique attributes.

At block 503, if an equivalent resource is not found in the new service design that matches a resource in the existing service design, it can be assumed to no longer be needed in the new service design. Thus, an instruction can be added to the new service design to have this resource deleted. To make such an instruction, the resource in the existing service design is first added to the new service design as a vertex, and at block 504, the action attribute value of the resource added to the new service design (in block 503) is set to “delete.” The instruction to delete this resource in inventory (e.g., remove the association between the resource with the service and hence, make the resource available for use by other services) is now complete.

At block 505, when an equivalent resource is found in the new service design matching a resource in the existing service design, the attribute values of the resources are compared to determine whether they are the same. In some embodiments, resource attributes that would end up being different for every execution of a design add function (e.g., connection IDs as described above, etc.), are not considered for this comparison.

At block 506, when the attribute values of the equivalent resource in the new service design are the same as the attribute values of the matching resource in the existing service design, then the action in the vertex of the resource is cleared. Recall that, in some embodiments, all service-specific resources of new service designs originally have their action attribute values set to “create.” Thus, clearing the action will ensure that such resources, which are not affected by the change (i.e., are not “new” with respect to the existing service design), will not be altered in inventory.

At block 507, when the attribute values of the equivalent resource in the new service design are different from the attribute values of the matching resource in the existing service design, then the action in the vertex of the resource is set to “UPDATE.” This results in an instruction to have the attributes of this resource be updated in inventory.

Another set of operations that may be performed for block 203 in FIG. 2—reconstructing the input data structure from the existing service design—will now be presented.

Thus, given the existing service design 202, the task is to “reconstruct” (or generate) the input data structure 204 that would have been used to create the service design in the first place. The actual logic will be specific to a particular implementation, though an example is provided here regarding a telecommunications system. Given the sample service design 600 construct and data in FIG. 6, the algorithm could be as follows.

First, iterate over all objects in the service design, searching for a single object of type “service.” The “name” of that service can be used to construct the initial input data structure as follows:

<service name=”MyService” >
</service>

Next, iterate over all “toObject” elements under the “terminatingPorts” association under the “object” representing “MyService.” For each such element (which represents a terminating port), add an “endpoint” element to the input data structure, setting the “name” of that “endpoint” to the “name” of the respective “toObject,” as follows:

<service name=”MyService” >

<endpoint name=”A” />
<endpoint name=”B”/>

</service>

The following describes exemplary output produced by the design add function 208 in FIG. 2. Since that step generates the new service design by assuming that everything is to be created, the service object and each logicalPort object all have an action attribute value of “create,” as shown below:

<serviceDesign>

<object type=“logicalPort” name=”A” action=”create”/>
<object type=“logicalPort” name=”X1” action=”create”/>
...
<object type=“logicalPort” name=”Xv” action=”create”/>
<object type=“logicalPort” name=”Xu” action=”create”/>
...
<object type=“logicalPort” name=”Xm” action=”create”/>
<object type=“logicalPort” name=”C” action=”create”/>
<object type=”service” name=”MyService” action=”create”>

<association name=”ports”>

<toObject name=”A”/>
<toObject name=”X1“/>
...
<toObject name=”Xv”/>
<toObject name=”Xu”/>
...
<toObject name=”Xm”/>
<toObject name=”C” />

</association>
<association name=”terminatingPorts”>

<toObject name=”A”/>
<toObject name=”C” />

</association>

<object>

</serviceDesign>

The following table describes exemplary output that could be produced by the differencing existing and new service designs block 210. Logical ports that are present in the existing service design (e.g., ports A, X₁ . . . Xᵥ) have their action removed as there is nothing to do. Logical ports that are present in the existing service design, but do not appear in the new service design (e.g., ports X_{w} . . . Xₙ, B), are added to the service design with the action of “delete.” Assuming that the service “MyService” did not have any attributes changed, its action can be removed as well, as it existed in the existing service design.

<serviceDesign>

<object type=“logicalPort” name=”A”/>
<object type=“logicalPort” name=”X1” />
...
<object type=“logicalPort” name=”Xv” />
<object type=“logicalPort” name=”Xu” action=”create”/>
...
<object type=“logicalPort” name=”Xm” action=”create”/>
<object type=“logicalPort” name=”C” action=”create”/>
<object type=“logicalPort” name=”Xw” action=”delete”/>
...
<object type=“logicalPort” name=”Xn” action=”delete”/>
<object type=“logicalPort” name=”B” action=”delete”/>
<object type=”service” name=”MyService”>
<association name=”ports”>

<toObject name=”A”/>
<toObject name=”X1“/>
...
<toObject name=”Xv”/>
<toObject name=”Xu”/>
...
<toObject name=”Xm”/>
<toObject name=”C” />

</association>
<association name=”terminatingPorts”>

<toObject name=”A”/>
<toObject name=”C” />

</association>
<object>

</serviceDesign>

This resultant service design can now be thought of as a list of “executable” instructions. Every object with an action represents such an instruction. Associations to/from such objects can also be automatically created or deleted.

We now turn to FIG. 9, which is a flow-type diagram illustrating operations 900 for updating a service by reconciling a stored input data structure (e.g., a copy of the input data structure actually used to create the existing service design) with a reconstructed input data structure according to some embodiments. This reconciliation involves what the CRM/OMS 102 may think the service is, and how that service is actually built in the inventory system 110A/110B (or actually built in the service infrastructure 112, such as when an inventory system 110A/110B is not utilized). These two places may become out of sync—i.e., have different views of the service—for a variety of reasons.

As one example, the CRM/OMS 102 may send a request to the service management module 104 to build a service between endpoints A and B. The CRM/OMS 102, at a later time, may send a request to the service management module 104 to change this service so that it is now between endpoints A and C. However, if the service management module 104 never receives that request (or acts upon the request), the inventory system 110A/110B will still contain the resources to provide connectivity between endpoints A and B. At the same time, the CRM/OMS 102 may think that its request was processed and that the inventory 200 contains the resources used to provide connectivity between endpoints A and C.

Another variation may occur when the CRM/OMS 102 sends a request to the service management module 104 to build a service between endpoints A and B, and a user, at a later time, goes into the inventory 200 and manually changes the resources so that they provide connectivity between endpoints A and C. Thus, the CRM/OMS 102 is unaware of that user's changes, and still thinks the service is between endpoints A and B.

Accordingly, maintaining and modifying (e.g., by the client 120 and/or CRM/OMS 102) an input data structure poses a risk that it is not in-sync with the inventory. Continuing the example, if a CRM/OMS 102 were to seek a small unrelated (to the actual discrepancy between endpoints B and C) change to be made to the service, the service could be caused to be rebuilt between endpoints A and B, as the processing would be based on the input stored by the CRM/OMS 102.

Therefore, it can be desirable to reconstruct the input based on existing information in inventory, rather than to maintain the input. However, if the nature of the system calls for maintaining the input data structure, certain constructs in place could be partially or completely re-used to reconcile that input with the inventory data, as described in FIG. 9, which can be used to determine the differences between the CRM/OMS 102 and the inventory 200.

At block 201, the existing service design is fetched from Inventory 200 based on the provided service name/identifier. That will generate an existing service design 202 (e.g., using an in-memory representation). At block 203, given the existing service design 202, the input data structure that would have been used to create such service design in the first place can be reconstructed.

At block 906, a difference between the stored input data structure 905 (e.g., a copy of the input data structure actually used to create the existing service design) and the reconstructed input data structure 204 can be determined. The result could be presented to a user for a decision, passed to a policy engine, etc., where at block 907 corrections are decided. This could be performed by specifying whether the inventory or the stored input value is correct. In some cases, corrections might be needed to both. If corrections are required to inventory, then an input data structure with a full service specification 909 can be generated. At block 908, if corrections are needed to the stored input, then the stored input can simply be updated.

At block 910, portions of the change flow can be executed (as described in FIGS. 2 and 3) with the corrected input data structure 909. In some embodiments, because this input contains a full specification, it can be used as-is and will not be reconstructed (as done in block 203).

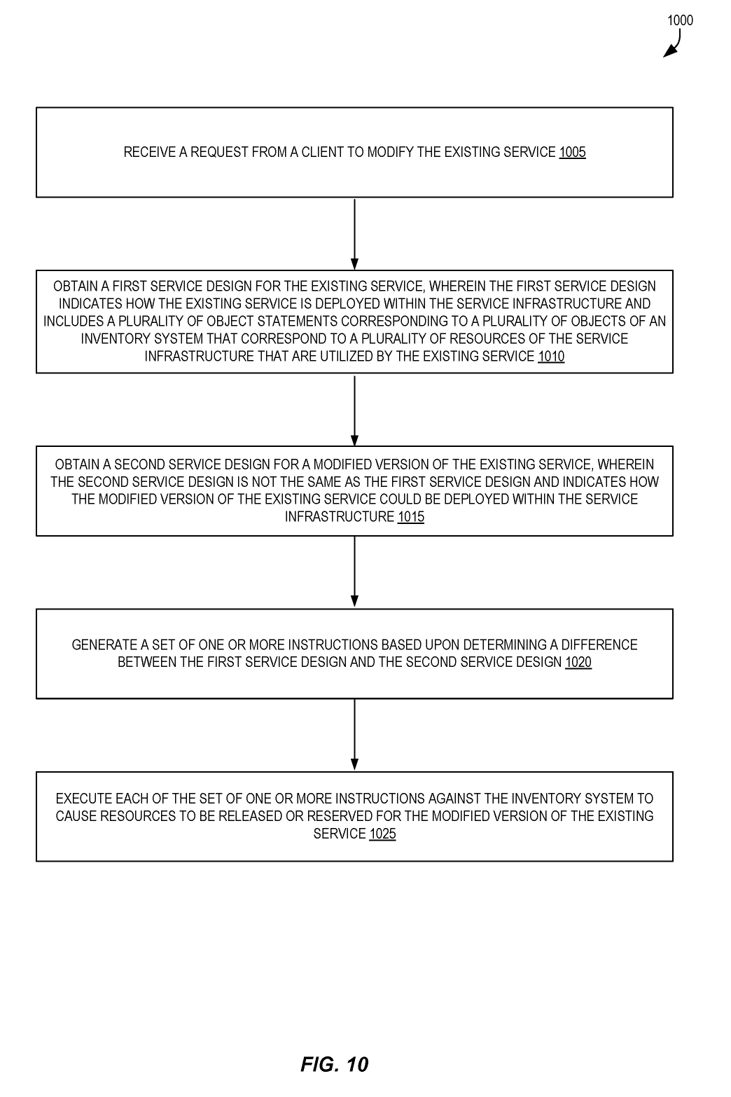

FIG. 10 is a flow diagram illustrating a flow 1000 for updating a service instance in a service infrastructure utilizing a split design-assign framework according to some embodiments. In some embodiments, the operations of the flow 1000 can be performed by the service management module 104 described herein.

At block 1005, the flow 1000 includes receiving a request from a client to modify the existing service. At block 1010, the flow 1000 includes obtaining a first service design for the existing service. The first service design indicates how the existing service is deployed within a service infrastructure and includes a plurality of object statements corresponding to a plurality of objects of an inventory system that correspond to a plurality of resources of the service infrastructure that are utilized by the existing service.

At block 1015, the flow 1000 includes obtaining a second service design for a modified version of the existing service. The second service design is not the same as the first service design and indicates how the modified version of the existing service could be deployed within the service infrastructure.

At block 1020, the flow 1000 includes generating a set of one or more modification instructions based upon determining a difference between the first service design and the second service design. At block 1025, the flow 1000 includes executing each of the set of one or more modification instructions against the inventory system to cause resources to be released or reserved for the modified version of the existing service.

Embodiments disclosed herein may involve the use of one or more electronic devices. An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) (NI) to establish network connections (to transmit and/or receive code and/or data using propagating signals) with other electronic devices. One or more parts of an embodiment may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

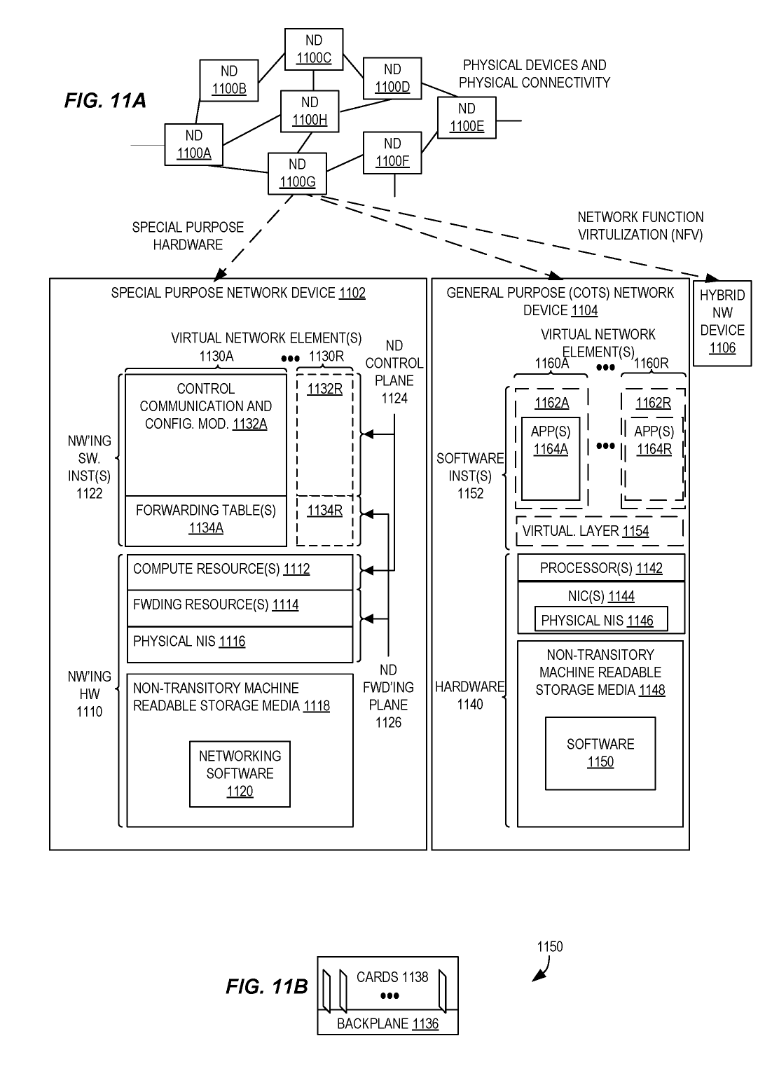

FIG. 11A illustrates connectivity between network devices (NDs) within an exemplary network, as well as three exemplary implementations of the NDs, according to some embodiments. FIG. 11A shows NDs 1100A-1100H, and their connectivity by way of lines between 1100A-1100B, 1100B-1100C, 1100C-1100D, 1100D-1100E, 1100E-1100F, 1100F-1100G, and 1100A-1100G, as well as between 1100H and each of 1100A, 1100C, 1100D, and 1100G. These NDs are physical devices, and the connectivity between these NDs can be wireless or wired (often referred to as a link). An additional line extending from NDs 1100A, 1100E, and 1100F illustrates that these NDs act as ingress and egress points for the network (and thus, these NDs are sometimes referred to as edge NDs; while the other NDs may be called core NDs).

Two of the exemplary ND implementations in FIG. 11A are: 1) a special-purpose network device 1102 that uses custom application-specific integrated-circuits (ASICs) and a special-purpose operating system (OS); and 2) a general purpose network device 1104 that uses common off-the-shelf (COTS) processors and a standard OS.

The special-purpose network device 1102 includes networking hardware 1110 comprising compute resource(s) 1112 (which typically include a set of one or more processors), forwarding resource(s) 1114 (which typically include one or more ASICs and/or network processors), and physical network interfaces (NIs) 1116 (sometimes called physical ports), as well as non-transitory machine readable storage media 1118 having stored therein networking software 1120. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 1100A-1100H. During operation, the networking software 1120 may be executed by the networking hardware 1110 to instantiate a set of one or more networking software instance(s) 1122. Each of the networking software instance(s) 1122, and that part of the networking hardware 1110 that executes that network software instance (be it hardware dedicated to that networking software instance and/or time slices of hardware temporally shared by that networking software instance with others of the networking software instance(s) 1122), form a separate virtual network element 1130A-1130R. Each of the virtual network element(s) (VNEs) 1130A-1130R includes a control communication and configuration module 1132A-1132R (sometimes referred to as a local control module or control communication module) and forwarding table(s) 1134A-1134R, such that a given virtual network element (e.g., 1130A) includes the control communication and configuration module (e.g., 1132A), a set of one or more forwarding table(s) (e.g., 1134A), and that portion of the networking hardware 1110 that executes the virtual network element (e.g., 1130A).

The special-purpose network device 1102 is often physically and/or logically considered to include: 1) a ND control plane 1124 (sometimes referred to as a control plane) comprising the compute resource(s) 1112 that execute the control communication and configuration module(s) 1132A-1132R; and 2) a ND forwarding plane 1126 (sometimes referred to as a forwarding plane, a data plane, or a media plane) comprising the forwarding resource(s) 1114 that utilize the forwarding table(s) 1134A-1134R and the physical NIs 1116. By way of example, where the ND is a router (or is implementing routing functionality), the ND control plane 1124 (the compute resource(s) 1112 executing the control communication and configuration module(s) 1132A-1132R) is typically responsible for participating in controlling how data (e.g., packets) is to be routed (e.g., the next hop for the data and the outgoing physical NI for that data) and storing that routing information in the forwarding table(s) 1134A-1134R, and the ND forwarding plane 1126 is responsible for receiving that data on the physical NIs 1116 and forwarding that data out the appropriate ones of the physical NIs 1116 based on the forwarding table(s) 1134A-1134R.

FIG. 11B illustrates an exemplary way to implement the special-purpose network device 1102 according to some embodiments. FIG. 11B shows a special-purpose network device including cards 1138 (typically hot pluggable). While in some embodiments the cards 1138 are of two types (one or more that operate as the ND forwarding plane 1126 (sometimes called line cards), and one or more that operate to implement the ND control plane 1124 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 1136 (e.g., a first full mesh coupling the line cards and a second full mesh coupling all of the cards).

Returning to FIG. 11A, the general purpose network device 1104 includes hardware 1140 comprising a set of one or more processor(s) 1142 (which are often COTS processors) and network interface controller(s) 1144 (NICs; also known as network interface cards) (which include physical NIs 1146), as well as non-transitory machine readable storage media 1148 having stored therein software 1150. During operation, the processor(s) 1142 execute the software 1150 to instantiate one or more sets of one or more applications 1164A-1164R. While one embodiment does not implement virtualization, alternative embodiments may use different forms of virtualization. For example, in one such alternative embodiment the virtualization layer 1154 represents the kernel of an operating system (or a shim executing on a base operating system) that allows for the creation of multiple instances 1162A-1162R called software containers that may each be used to execute one (or more) of the sets of applications 1164A-1164R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the mentor)/of the other processes. In another such alternative embodiment the virtualization layer 1154 represents a hypervisor (sometimes referred to as a virtual machine monitor (VMM)) or a hypervisor executing on top of a host operating system, and each of the sets of applications 1164A-1164R is run on top of a guest operating system within an instance 1162A-1162R called a VM (which may in some cases be considered a tightly isolated form of software container) that is run on top of the hypervisor—the guest operating system and application may not know they are running on a VM as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 1140, directly on a hypervisor (in which case the unikernel is sometimes described as running within a LibOS VM), or in a software container, embodiments can be implemented fully with unikernels running directly on a hypervisor represented by virtualization layer 1154, unikernels running within software containers represented by instances 1162A-1162R, or as a combination of unikernels and the above-described techniques (e.g., unikernels and VMs both run directly on a hypervisor, unikernels and sets of applications that are run in different software containers).

The instantiation of the one or more sets of one or more applications 1164A-1164R, as well as virtualization if implemented, are collectively referred to as software instance(s) 1152. Each set of applications 1164A-1164R, corresponding virtualization construct (e.g., instance 1162A-1162R) if implemented, and that part of the hardware 1140 that executes them (be it hardware dedicated to that execution and/or time slices of hardware temporally shared), forms a separate virtual network element(s) 1160A-1160R.

The virtual network element(s) 1160A-1160R perform similar functionality to the virtual network element(s) 1130A-1130R—e.g., similar to the control communication and configuration module(s) 1132A and forwarding table(s) 1134A (this virtualization of the hardware 1140 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments are illustrated with each instance 1162A-1162R corresponding to one VNE 1160A-1160R, alternative embodiments may implement this correspondence at a finer level granularity (e.g., line card VMs virtualize line cards, control card VMs virtualize control cards, etc.); it should be understood that the techniques described herein with reference to a correspondence of instances 1162A-1162R to VNEs also apply to embodiments where such a finer level of granularity and/or unikernels are used.

In certain embodiments, the virtualization layer 1154 includes a virtual switch that provides similar forwarding services as a physical Ethernet switch. Specifically, this virtual switch forwards traffic between instances 1162A-1162R and the NIC(s) 1144, as well as optionally between the instances 1162A-1162R; in addition, this virtual switch may enforce network isolation between the VNEs 1160A-1160R that by policy are not permitted to communicate with each other (e.g., by honoring virtual local area networks (VLANs)).

The third exemplary ND implementation in FIG. 11A is a hybrid network device 1106, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 1102) could provide for para-virtualization to the networking hardware present in the hybrid network device 1106.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 1130A-1130R, VNEs 1160A-1160R, and those in the hybrid network device 1106) receives data on the physical NIs (e.g., 1116, 1146) and forwards that data out the appropriate ones of the physical NIs (e.g., 1116, 1146). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

The NDs of FIG. 11A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, Global Positioning Satellite (GPS) units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 11A may also host one or more such servers (e.g., in the case of the general purpose network device 1104, one or more of the software instances 1162A-1162R may operate as servers; the same would be true for the hybrid network device 1106; in the case of the special-purpose network device 1102, one or more such servers could also be run on a virtualization layer executed by the compute resource(s) 1112); in which case the servers are said to be co-located with the VNEs of that ND.

A virtual network is a logical abstraction of a physical network (such as that in FIG. 11A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet Local Area Network (LAN) emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Each VNE (e.g., a virtual router, a virtual bridge (which may act as a virtual switch instance in a Virtual Private Local Area Network Service (VPLS) is typically independently administrable. For example, in the case of multiple virtual routers, each of the virtual routers may share system resources but is separate from the other virtual routers regarding its management domain, AAA (authentication, authorization, and accounting) name space, IP address, and routing database(s). Multiple VNEs may be employed in an edge ND to provide direct network access and/or different classes of services for subscribers of service and/or content providers.

Some NDs provide support for implementing VPNs (Virtual Private Networks) (e.g., Layer 2 VPNs and/or Layer 3 VPNs). For example, the ND where a provider's network and a customer's network are coupled are respectively referred to as PEs (Provider Edge) and CEs (Customer Edge). In a Layer 2 VPN, forwarding typically is performed on the CE(s) on either end of the VPN and traffic is sent across the network (e.g., through one or more PEs coupled by other NDs). Layer 2 circuits are configured between the CEs and PEs (e.g., an Ethernet port, an ATM permanent virtual circuit (PVC), a Frame Relay PVC). In a Layer 3 VPN, routing typically is performed by the PEs. By way of example, an edge ND that supports multiple VNEs may be deployed as a PE; and a VNE may be configured with a VPN protocol, and thus that VNE is referred as a VPN VNE.

While the flow diagrams in the figures show a particular order of operations performed by certain embodiments, it should be understood that such order is exemplary (e.g., alternative embodiments may perform the operations in a different order, combine certain operations, overlap certain operations, etc.).

Additionally, while the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method in a service management module implemented by one or more computing devices for modifying an existing service utilizing a split design-assign framework, the method comprising:
receiving, at the service management module, a request from a client to modify the existing service;
obtaining, by a design module of the service management module, a first service design for the existing service, wherein the first service design indicates how the existing service is deployed within a service infrastructure and includes a plurality of object statements corresponding to a plurality of objects of an inventory system that correspond to a plurality of resources of the service infrastructure that are utilized by the existing service;
obtaining, by the design module, a second service design for a modified version of the existing service, wherein the second service design is not the same as the first service design and indicates how the modified version of the existing service could be deployed within the service infrastructure;
generating, by the design module, a set of one or more instructions based upon determining a difference between the first service design and the second service design; and
executing, by an assign module of the service management module, each of the set of one or more instructions against the inventory system to cause resources to be released or reserved for the modified version of the existing service.

2. The method of claim 1, wherein the request includes a change input data structure identifying a set of one or more changes to the existing service.

3. The method of claim 2, further comprising:
obtaining, by the design module, a first input data structure based upon the first service design, wherein the first input data structure comprises less data than the first service design and describes requirements for the existing service from a perspective of the client; and
generating, by the design module, a second input data structure corresponding to the modified version of the existing service based upon both the first input data structure and the change input data structure,
wherein said obtaining the second service design comprises generating the second service design based upon the second input data structure.

4. The method of claim 3, wherein said obtaining the first input data structure comprises:
reconstructing the first input data structure based upon the first service design;
comparing the first input data structure to a stored copy of another input data structure to determine whether a difference exists between the first input data structure and the stored copy;
responsive to determining that the difference exists, updating either the first input data structure or the stored copy.

5. The method of claim 1, wherein the request comprises a second input data structure corresponding to the modified version of the existing service, wherein the second input data structure comprises the second service design.

6. The method of claim 1, wherein each of the set of one or more instructions is either an add instruction, a change instruction, or a delete instruction, and wherein each of the set of one or more instructions corresponds to a resource utilized for the existing service or a new resource to be utilized for the modified version of the existing service.

7. The method of claim 6, wherein the resource corresponding to at least one of the set of one or more instructions is either a port, a time slot, or a connection identifier.

8. A non-transitory machine-readable storage medium that provides instructions which, when executed by a processor of a device, will cause said device to implement a service management module operable to modify an existing service utilizing a split design-assign framework by performing operations comprising:
receiving, at the service management module, a request from a client to modify the existing service;
obtaining, by a design module of the service management module, a first service design for the existing service, wherein the first service design indicates how the existing service is deployed within a service infrastructure and includes a plurality of object statements corresponding to a plurality of objects of an inventory system that correspond to a plurality of resources of the service infrastructure that are utilized by the existing service;
obtaining, by the design module, a second service design for a modified version of the existing service, wherein the second service design is not the same as the first service design and indicates how the modified version of the existing service could be deployed within the service infrastructure;
generating, by the design module, a set of one or more instructions based upon determining a difference between the first service design and the second service design; and
executing, by an assign module of the service management module, each of the set of one or more instructions against the inventory system to cause resources to be released or reserved for the modified version of the existing service.

9-11. (canceled)

12. The non-transitory machine-readable storage medium of claim 8, wherein the request includes a change input data structure identifying a set of one or more changes to the existing service.

13. The non-transitory machine-readable storage medium of claim 12, wherein the operations further comprise:
obtaining, by the design module, a first input data structure based upon the first service design, wherein the first input data structure comprises less data than the first service design and describes requirements for the existing service from a perspective of the client; and
generating, by the design module, a second input data structure corresponding to the modified version of the existing service based upon both the first input data structure and the change input data structure,
wherein said obtaining the second service design comprises generating the second service design based upon the second input data structure.

14. The non-transitory machine-readable storage medium of claim 13, wherein said obtaining the first input data structure comprises:
reconstructing the first input data structure based upon the first service design;
comparing the first input data structure to a stored copy of another input data structure to determine whether a difference exists between the first input data structure and the stored copy; and
responsive to determining that the difference exists, updating either the first input data structure or the stored copy.

15. The non-transitory machine-readable storage medium of claim 8, wherein the request comprises a second input data structure corresponding to the modified version of the existing service, wherein the second input data structure comprises the second service design.

16. The non-transitory machine-readable storage medium of claim 8, wherein each of the set of one or more instructions is either an add instruction, a change instruction, or a delete instruction, and wherein each of the set of one or more instructions corresponds to a resource utilized for the existing service or a new resource to be utilized for the modified version of the existing service.

17. The non-transitory machine-readable storage medium of claim 16, wherein the resource corresponding to at least one of the set of one or more instructions is either a port, a time slot, or a connection identifier.

18. A device to modify an existing service utilizing a split design-assign framework, the device comprising:
one or more processors; and
a non-transitory machine-readable storage medium having instructions which, when executed by the one or more processors, will cause said device to implement a service management module operable to perform operations comprising:
receiving, at the service management module, a request from a client to modify the existing service;
obtaining, by a design module of the service management module, a first service design for the existing service, wherein the first service design indicates how the existing service is deployed within a service infrastructure and includes a plurality of object statements corresponding to a plurality of objects of an inventory system that correspond to a plurality of resources of the service infrastructure that are utilized by the existing service;
obtaining, by the design module, a second service design for a modified version of the existing service, wherein the second service design is not the same as the first service design and indicates how the modified version of the existing service could be deployed within the service infrastructure;
generating, by the design module, a set of one or more instructions based upon determining a difference between the first service design and the second service design; and
executing, by an assign module of the service management module, each of the set of one or more instructions against the inventory system to cause resources to be released or reserved for the modified version of the existing service.

19. The device of claim 18, wherein the request includes a change input data structure identifying a set of one or more changes to the existing service.

20. The device of claim 19, wherein the operations further comprise:
obtaining, by the design module, a first input data structure based upon the first service design, wherein the first input data structure comprises less data than the first service design and describes requirements for the existing service from a perspective of the client; and
generating, by the design module, a second input data structure corresponding to the modified version of the existing service based upon both the first input data structure and the change input data structure,
wherein said obtaining the second service design comprises generating the second service design based upon the second input data structure.

21. The device of claim 20, wherein said obtaining the first input data structure comprises:
reconstructing the first input data structure based upon the first service design;
comparing the first input data structure to a stored copy of another input data structure to determine whether a difference exists between the first input data structure and the stored copy; and
responsive to determining that the difference exists, updating either the first input data structure or the stored copy.

22. The device of claim 18, wherein the request comprises a second input data structure corresponding to the modified version of the existing service, wherein the second input data structure comprises the second service design.

23. The device of claim 18, wherein each of the set of one or more instructions is either an add instruction, a change instruction, or a delete instruction, and wherein each of the set of one or more instructions corresponds to a resource utilized for the existing service or a new resource to be utilized for the modified version of the existing service.
